(19) United States
(12) Patent Application Publication
(10) Pub. No.: US 2005/0195688 A1
(43) Pub. Date: Sep. 8, 2005

(54) Schedule management apparatus

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS COMPANY, LTD., Kumamoto-shi (JP)

(21) Appl. No.: 11/068,883

(22) Filed: Mar. 2, 2005

(30) Foreign Application Priority Data
Mar. 8, 2004 (JP) 2004-064707

(51) Int. Cl. G06F 17/60

(52) U.S. Cl. 368/10; 705/8

(57) ABSTRACT

A schedule management apparatus comprises a setting device, and a notifying device. The setting device sets a date and time and contents of schedule. The notifying device notifies the contents of the schedule at the set date and time.

### CROSS-REFERENCE TO RELATED APPLICATIONS

This application is based upon and claims the benefit of priority from prior Japanese Patent Application No. 2004-064707, filed Mar. 8, 2004, the entire contents of which are incorporated herein by reference.

### BACKGROUND OF THE INVENTION

1. Field of the Invention

The present invention relates to a schedule management apparatus, which displays the contents of a schedule beside the date and time.

2. Description of the Related Art

There are many schedule management items: for example, personal computers, cellular phones and portable digital assistants. However, since an elderly person in general cannot use these items very well, he or she tends to rely on a conventional clock, which is the most familiar item, to manage schedules.

However, a conventional clock only has a clock function to display the date and time and an alarm function to inform the user of a preset time. There is no clock, by which the user can easily set a schedule, such as a date and time to perform a predetermined action, for example, to take a medicine, and which accurately manages and displays the schedule.

Therefore, if a person needs to take a medicine at a predetermined date and time, the person him or herself or an entrusted person, such as a nurse, must manually manage the schedule. The manual management may cause various problems: for example, the person may take the medicine at a wrong date and time, forget to take the medicine, take another medicine by mistake, or take the medicine doubly.

### BRIEF SUMMARY OF THE INVENTION

An object of the present invention is to provide a schedule management apparatus, by which schedules, such as a date and time to perform a predetermined action, are set and notified.

According to an aspect of the present invention, a schedule management apparatus comprises a setting device which sets a date and time and contents of schedule; and a notifying device which notifies the contents of the schedule at the set date and time.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an exterior of a clock-type schedule management apparatus according to a first embodiment of the present invention;

FIG. 2 is a perspective view showing a main part of a second embodiment of the present invention; and

FIG. 3 is a perspective view showing an exterior of a clock-type schedule management apparatus according to a third embodiment of the present invention.

### DETAILED DESCRIPTION OF THE INVENTION

Embodiments of the present invention will be described in detail below with reference to the accompanying drawings.

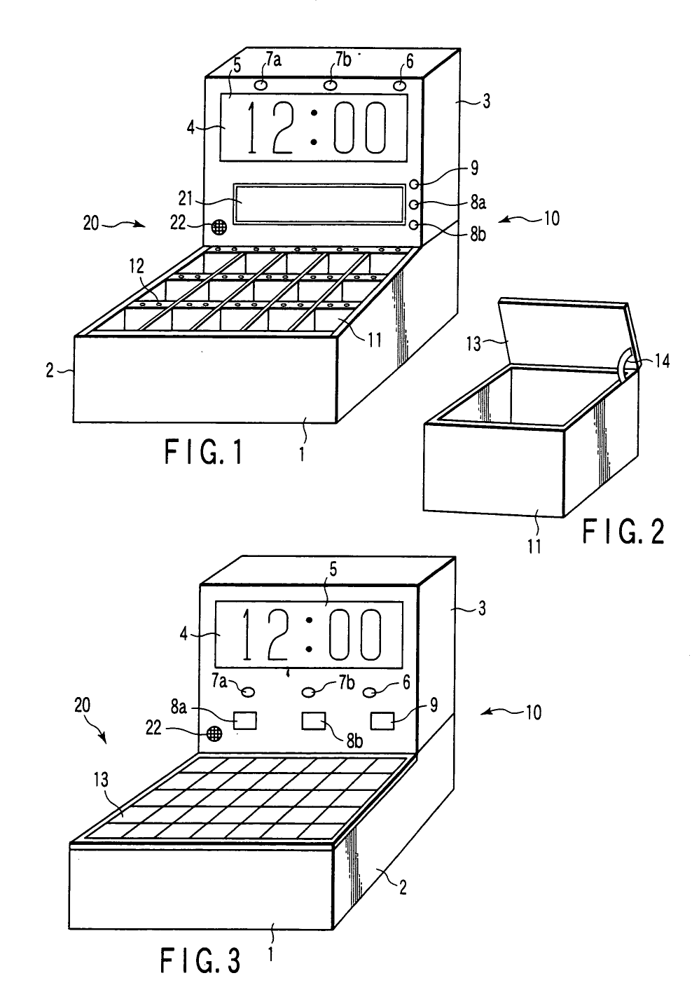

FIG. 1 is a perspective view showing an exterior of a clock-type schedule management apparatus according to a first embodiment of the present invention.

An apparatus main body 1 has a base portion 2 which is placed on a desk or the like and a backside upright portion 3 which stands upright at the distal end of the base portion 2. The backside upright portion 3 includes a clock device 5 having a clock display device 4, which displays a date and time.

The clock device 5 incorporates a schedule management program (not shown). The schedule management program manages various personal schedules in association with the set dates and times. The clock device 5 transmits the set and managed schedules to a notifying device 20 (to be described later) on the corresponding dates and times.

Personal daily schedule items are input to or stored in advance in the schedule management program (not shown) incorporated in the clock device 5. If necessary, additional items can be input to the schedule management program.

The schedule items input to or stored in the schedule management program are “meeting”, “visitor”, “business trip”, “submission of report”, etc. for business use. The program contains, as items for personal use, such as taking a medicine, “time to take morning medicine”, “time to take afternoon medicine”, “time to take night medicine”, “take a medicine before meal”, “take a medicine after meal”, “take medicine between meals”, “take medicine before sleep”, etc. Further, the program contains, as other items of daily schedules, “lesson”, “shopping”, “meeting at the child's school”, “meeting of residents' association”, “garbage collection”, etc. Of these items, the schedule items that the user requires are set and managed in association with the date and time by means of a setting device 10 to be described below.

In this embodiment, the setting device 10 is provided in the apparatus main body 1. It has a date setting button 6, an hour setting button 7a, a minute setting button 7b, a program up button 8a, a program down button 8b, an item setting button 9, etc.

The date setting button 6 is used to set the date to execute the schedule in the schedule management program incorporated in the clock device 5.

The hour setting button 7a and the minute setting button 7b are used to set the time to execute the schedule.

The program up button 8a and the program down button 8b are used to call a schedule item from the items stored in the schedule management program, and display it on a text display device 21 to be described later.

The setting device 10 may be operated by, for example, a remote controller. Therefore, the setting device 10 is not necessarily provided in the apparatus main body 1.

How to display the schedule item can be selectively set in the setting device 10: whether to display it on the scheduled date or the day before, and whether to display it once or a plurality of times. How to notify the schedule can also be selectively set in the setting device 10: whether to notify it by voice, lighting of an indicator or both.

In this embodiment, a container 11, segmented into fifteen boxes, is provided on the base portion 2 of the apparatus main body 1. The user can store items related to the scheduled action, for example medicines, in the boxes of the container 11 for the respective dates. In this case, the medicines for fifteen days can be stored in the boxes of the container 11.

Indicators 12 are arranged for the respective boxes of the container 11, as shown in FIG. 1. The indicator 12 is made to blink, when it receives a command from the clock device 5 on the scheduled date and time. As a result, the user can identify the box of the container 11 corresponding to the date to take a medicine, and take out the medicine from the box of which indicator 12 is blinked.

Although the container 11 is segmented into fifteen boxes to store medicines for fifteen days, the number of boxes is not limited to fifteen. The container 11 may be segmented to store medicines for a week or a month.

When it is time to execute the schedule, or a few days or a few hours before the time, the notifying device 20 notifies the fact by a signal, such as voice or a light, and displays it with letters. In this embodiment, the notifying device 20 comprises a text display device 21, an alarm 22 and the indicator 12.

The text display device 21 is provided on the backside upright portion 3 of the apparatus main body 1. When the text display device 21 receives a command from the clock device 5 on the date and time to execute a schedule, it displays the contents of the schedule with letters.

For example, at seven o'clock in the morning of April 22, the text display device 21 displays the schedules on the scheduled date and thereafter: “take morning medicine (before breakfast)”, “meeting at three o'clock”, “golf tomorrow”, etc.

The alarm 22 is provided on the backside upright portion 3 of the apparatus main body 1. The alarm 22 notifies, with voice, the contents of the above schedules displayed on the text display device 21.

The indicator 12 blinks to identify the box of the container 11 corresponding to the scheduled date and containing a medicine to be taken at that time.

In this embodiment, on the scheduled date and time, the contents of the schedules of that day and thereafter are displayed with letters on the text display device 21, and notified by voice from the alarm 22. In addition, the indicator 12 is made to blink to identify the box of the container 11 corresponding to the scheduled date and containing a medicine to be taken at that time. However, the notice and display operation may be carried out a few days or a few hours before the scheduled date and time.

Other embodiments of the schedule management apparatus according to the present invention will be described. The same portions as those of the first embodiment will be indicated in the same reference numerals and their detailed description will be omitted. FIG. 2 is a perspective view showing a main part of a second embodiment of the present invention.

Each of the boxes of the container 11 has a lid 13, which is manually opened and closed. The lid 13 of each box has a notifying device (not shown), which notifies or displays the schedule, such as to take a medicine, at the scheduled time or a few hours before.

The notifying device of each lid 13 has a timer (not shown), which is activated by a switch 14, when the lid 13 is closed. At the time when the timer is activated, the schedule management program starts time management which ends at the scheduled date and time. At the scheduled date and time or a few hours before, the notice and display device performs a notice and display operation upon receipt of a command from the clock device 5.

FIG. 3 is a perspective view showing an exterior of a clock-type schedule management apparatus according to a third embodiment of the present invention. The third embodiment is a combination of the first and second embodiments. Each box of the container 11 has the lid 13 on which a display device is provided. The display device displays a schedule such as “take morning medicine (before breakfast)”, “meeting at three o'clock”, “golf tomorrow”, etc. on the scheduled data and time or a few hours before. The lid 13 may be manually or automatically opened and closed. The display device on the lid 13 also has the same function of that of the indicator 12, i.e. the display is blinked to inform the user of the scheduled date and time. When the display device on the lid 13 receives a command to display letters from the clock device 5, it displays the item of the set schedule in a part which can display letters. At the same time, the indicator 12 of the part corresponding to the scheduled date is turned on.

An operation of the clock-type schedule management apparatus of the present embodiment will be described.

First, the user sets a personal schedule, such as when to take a medicine, along with the corresponding date and time using the clock device 5.

More specifically, the user selects a schedule item contained in the schedule management program by depressing the program up button 8a and the program down button 8b, and set the selected item by depressing the item setting button 9.

Further, the user sets the date and time by depressing the day setting button 6, the hour setting button 7a and the minute setting button 7b.

Then, when a lid 13 is closed, the switch 14 activates the timer. With the activation of the timer, the schedule management program starts time management which is continued to be activated until the scheduled date and time.

The clock device 5 transmits a notifying command to the notifying device 20 at the scheduled date and time.

Then, upon receipt of the notifying command from the clock device 5, the display device on the lid 13 displays the contents of the schedule on that date with letters. In addition, the alarm 22 of the notifying device 20 notifies the schedule with a sound signal, and the indicator 12 on the lid 13, corresponding to the date to take a medicine, is made to blink to identify the box.

As described above, according to the present embodiment, the schedule is set to and managed by the clock device in association with the date and time. The present embodiment has an advantage that the user can automatically be notified of the contents of the schedule with a display of letters, and a signal, such as voice or a light, at the scheduled date and time or an earlier date and time.

Moreover, according to the present embodiment, the schedule box is segmented into a plurality of parts and medicines to be taken in a day can be stored in the corresponding part of the box. The schedule management apparatus of the present embodiment notifies the user of the date and time to take the medicine with a recognition signal, such as voice and light of the indicator, and displays the contents of the schedule with letters. Thus, the user can pick out a medicine from the corresponding box of the container, and take it correctly. Consequently, the problems caused by the conventional manual schedule management can be solved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A schedule management apparatus comprising:
a setting device which sets a date and time and contents of schedule; and
a notifying device which notifies the contents of the schedule at the set date and time.

2. The schedule management apparatus according to claim 1, wherein the setting device has setting button and a schedule management program.

3. The schedule management apparatus according to claim 1, wherein the notifying device notifies the contents of the schedule by voice and displays it with letters.

4. The schedule management apparatus according to claim 1, further comprising a container which is segmented into boxes corresponding to dates and wherein the notifying device has indicators for the respective boxes of the container to indicate the recognition signal on the box corresponding to the scheduled date.

5. The schedule management apparatus according to claim 4, wherein the boxes of the container have lids, and the notifying device has portions corresponding to dates on the lids.

6. The schedule management apparatus according to claim 4, wherein the container is configured to store medicines in the respective boxes.
